(19) United States
(12) Patent Application Publication
(10) Pub. No.: US 2013/0182080 A1
(43) Pub. Date: Jul. 18, 2013

(54) CAMERA TESTING DEVICE AND METHOD FOR TESTING CAMERA

(71) Applicants: YU-CHENG LIN, Tu-Cheng (TW); CHI-HSIANG PENG, Tu-Cheng (TW); CHIEH-WEN HSUEH, Tu-Cheng (TW)

(72) Inventors: YU-CHENG LIN, Tu-Cheng (TW); CHI-HSIANG PENG, Tu-Cheng (TW); CHIEH-WEN HSUEH, Tu-Cheng (TW)

(73) Assignee: HON HAI PRECISION INDUSTRY CO., LTD., Tu-Cheng (TW)

(21) Appl. No.: 13/430,696

(22) Filed: Mar. 27, 2012

(30) Foreign Application Priority Data
Jan. 12, 2012 (TW) 101101166

(51) Int. Cl. H04N 17/06; H04N 13/02

(52) U.S. Cl. 348/47; 348/E13.074; 348/E17.002

(57) ABSTRACT

A method for testing a 3D camera is provided. The method includes: making a first camera of the 3D camera align with a first picture of a reference picture, wherein, the reference picture includes a second picture, a central point of the first picture and the second picture respectively has a first label and a second label; obtaining an image captured by a second camera of the 3D camera; identifying the first label, the second label, and a central point of the image; calculating an actual angle difference and an actual distance difference according to coordinates of the first label, the second label, and the central point; determining whether the 3D camera is installed appropriately by comparing the actual distance difference with the reference distance difference and the actual angle difference with the reference angle difference respectively.

### BACKGROUND

1. Technical Field

The present disclosure relates to test devices, particularly, to a camera testing device.

2. Description of Related Art

Nowadays, 3D cameras (three-dimensional cameras) are more and more popular. Usually, a 3D camera includes two cameras, and in order to guarantee the quality of the 3D camera, a test for the camera is needed before leaving the factory. An important test item is to test whether the images captured by the two cameras are superposed within a certain range. However, conventional testing devices are usually expensive.

Therefore, it is desirable to provide a camera testing device and method to overcome the described limitations.

### BRIEF DESCRIPTION OF THE DRAWINGS

Many aspects of the present disclosure are better understood with reference to the drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a camera testing device for testing a 3D camera, in accordance with an exemplary embodiment.

FIG. 2 is a schematic diagram showing a reference picture set on the front of the 3D camera tested by the camera testing device of FIG. 1.

FIG. 3 is a schematic diagram showing an image captured by one camera of the 3D camera tested by the camera testing device of FIG. 1.

FIG. 4 is a flowchart illustrating a method for testing a 3D camera applied in a camera testing device, such as that of FIG. 1, in accordance with an exemplary embodiment.

### DETAILED DESCRIPTION

Embodiments of the present disclosure will now be described in detail, with reference to the accompanying drawings.

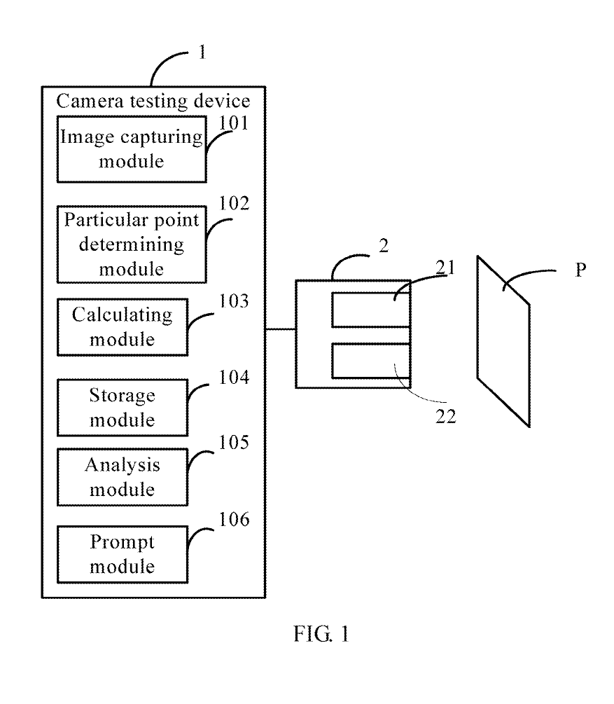

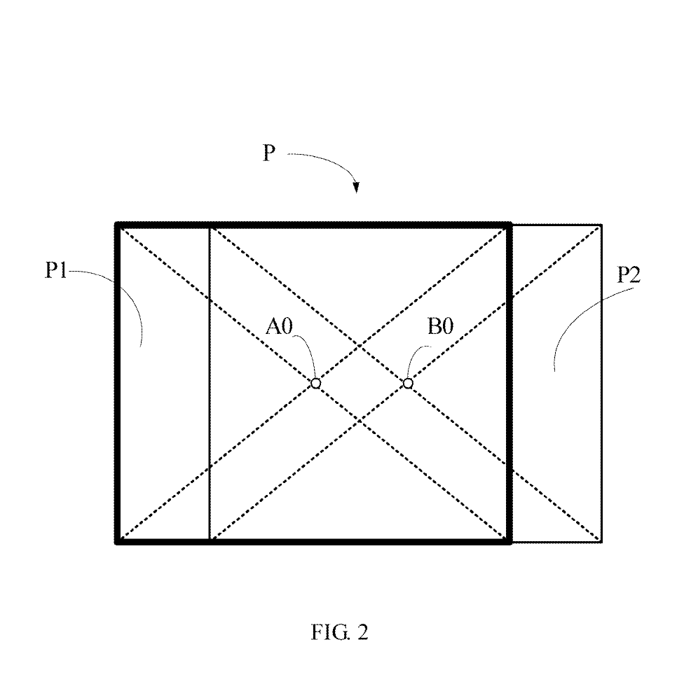

Referring to FIGS. 1 and 2, a camera testing device 1 connected to a 3D camera 2 for testing whether the installation of a first camera 21 and a second camera 22 of the 3D camera 2 satisfy general requirements is shown. The camera testing device 1 includes an image capturing module 101, a particular point determining module 102, a calculating module 103, a storage module 104, and an analysis module 105.

The image capturing module 101 obtains images captured by the first camera 21 and the second camera 22 of the 3D camera 2. In the embodiment, the 3D camera 2 is aimed at a reference picture P as shown in FIG. 2 to capture an image corresponding to the reference picture P. As shown in FIG. 2, the reference picture P includes a first picture P1 and a second picture P2. In the embodiment, the first picture P1 and the second picture P2 both are rectangles which correspond to the finder frame (not shown) of the first camera 21 and the second camera 22, and a central point of the first picture P1 has a first label A0, a central point of the second picture P2 has a second label B0. The first label A0 and the second label B0 can be a distinctive object, for example, such as a red point, or a small ring set on the first figure P1 and the second figure P2 by a user.

In the embodiment, the first camera 21 is aligned with the first picture P1 to allow the first picture P1 to overlap with the image captured by the first camera 21. In the embodiment, the position of the 3D camera 2 can be adjusted to make the first camera 21 align with the first picture P1. For example, the reference picture P is set on the front of the 3D camera 2, the 3D camera 2 is placed on a six-axis platform, and the user adjusts the position of the 3D camera 2 to make the first camera 21 align with the first picture P1.

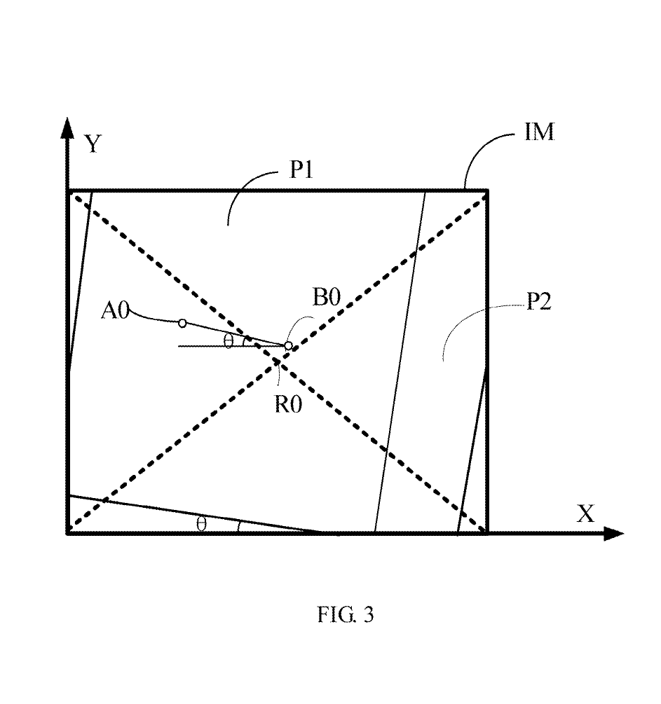

Referring also to FIG. 3, in the embodiment, if the installation of the 3D camera 2 is in the perfect state, that is, the first camera 21 is aligned with the first picture P1 completely and the second camera 22 is also aligned with the second picture P2 completely, the second camera 22 is regarded as being in a standard position. However, in fact, when the first camera 21 is aligned with the first picture P1, the second camera 22 cannot be aligned with the second picture P2 completely. As shown in FIG. 3, an image IM captured by the second camera 22 is not overlapping with the second picture P2.

The particular point determining module 102 analyzes the image IM captured by the second camera 22, and identifies the first label A0, the second label B0, and the central point R0 of the image IM. For example, the particular point determining module 102 analyzes image data of the image IM to determine the red point or the small ring to identify the first label A0 and the second label B0, and then determines the central point RO of the image IM. In the embodiment, each pixel point of the image IM corresponds to one coordinates of a coordinate system, such as a rectangular coordinate system, the horizontal bottom side of the image IM is regarded as an X-axis of the rectangular coordinate system, and the vertical left side of the image IM is regarded as a Y-axis of the rectangular coordinate system.

The calculating module 103 determines the coordinates of the first label A0, the second label B0, and the central point R0 of the image IM, and calculates an actual angle difference and an actual distance difference between the actual position of the second camera 22 and the standard position which will be described in detail below.

In detail, as described above, if the second camera 22 is at the standard position, the image IM overlaps the second picture P2 when the first camera 21 is aligned with the first picture P1, namely, the second label B0 overlaps the central point R0 of the image, and a connection line L1 of the first label A0 and the second label B0 is parallel to a horizontal side of the image IM. In the embodiment, when the second camera 22 is not in the standard position, the distance difference between the central point R0 of the image IM and the second label B0 is regarded as the actual distance difference between the actual position of the second camera 22 and the standard position, the angle difference between the connection line L1 and the horizontal side of the image IM is regarded as the actual angle difference between the actual position of the camera 22 and the standard position.

The calculating module 103 calculates a coordinate distance according to the coordinates of the central point R0 of the image IM and the coordinates of the second label B0 to obtain the actual distance difference between the actual position of the second camera 22 and the standard position, and calculates a slope of the connection line L1 according to the coordinates of the first label A0 and the coordinates of the second label B0 to obtain the actual angle difference between the actual position of the camera 22 and the standard position.

The storage module 104 stores a reference distance difference and a reference angle difference. The reference distance difference is the permitted maximum distance difference between the actual position of the camera 22 and the standard position, and the reference angle difference is the permitted maximum angle difference between the actual position of the camera 22 and the standard position.

The analysis module 105 compares the actual distance difference with the reference distance difference and compares the actual angle difference with the reference angle difference respectively to obtain corresponding comparison results, and determines whether the installation of the 3D camera 2 satisfies the requirement according to the comparison results. In detail, the analysis module 105 determines the installation of the 3D camera 2 satisfies the requirement if the actual distance difference is less than the reference distance difference and the angle difference is less than the reference angle difference. The analysis module 105 determines the 3D camera is not installed appropriately if the actual distance difference is greater than the reference distance difference or the angle difference is greater than the reference angle difference.

In the embodiment, the camera testing device 1 also includes a prompt module 106. The analysis module 105 controls the prompt module 106 to produce corresponding prompt signals according to the comparison results. For example, the prompt module 106 can be a LED (Light-Emitting Diode) unit, the analysis module 105 controls the prompt module 106 to show the light on when the 3D camera 2 is installed appropriately, and controls the prompt module 106 to flash the light when the 3D camera 2 is not installed appropriately. In other embodiments, the prompt module 106 can be an audio output unit.

In the embodiment, the first camera 21 is a left camera of the 3D camera 2 and the second camera 21 is a right camera of the 3D camera 2. In other embodiments, the first camera 21 can be the right camera of the 3D camera 2 and the second camera 22 can be the left camera of the 3D camera 2.

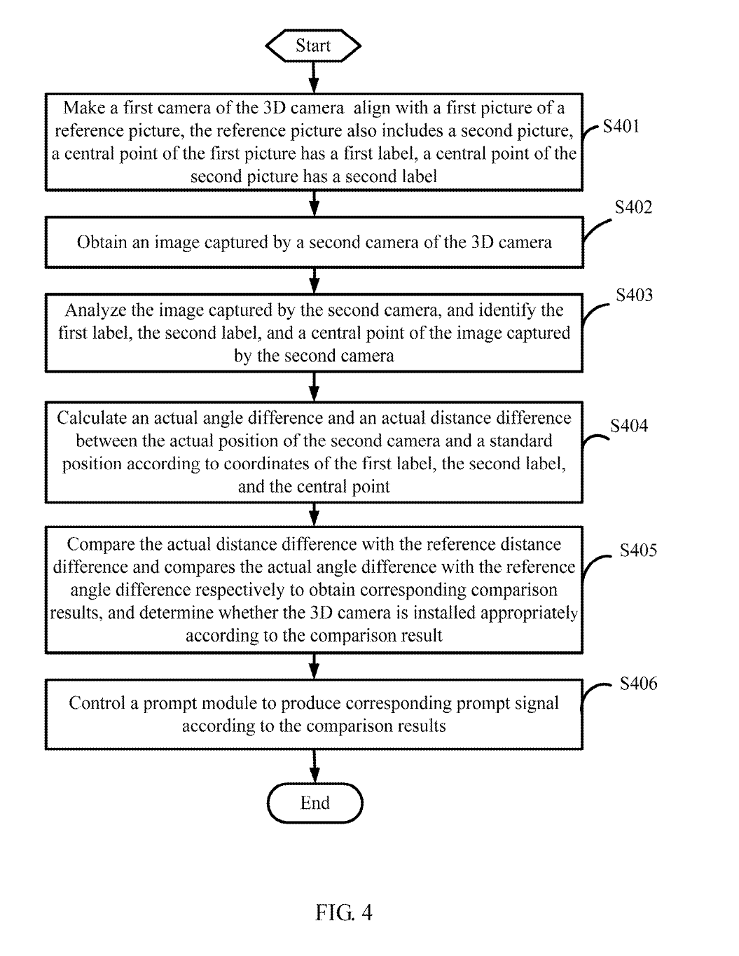

FIG. 4 is a flowchart showing a method for testing a 3D camera, applied in the camera testing device of FIG. 1.

In step S401, the position of the 3D camera 2 is adjusted to make the first camera 21 of the 3D camera 2 align with the first picture P1 of the reference picture P.

In step S402, the image capturing module 101 obtains the image IM captured by the second camera 22 of the 3D camera 2.

In step S403, the particular point determining module 102 analyzes the image IM captured by the second camera 22, and identifies the first label A0, the second label B0, and the central point R0 of the image IM.

In step S404, the calculating module 103 determines the coordinates of the first label A0, the second label B0, and the central point R0 of the image IM, and calculates the actual angle difference and the actual distance difference between the actual position of the second camera 22 and the standard position according to the coordinates of the first label A0, the second label B0, and the central point R0 of the image IM.

In step S405, the analysis module 105 compares the actual distance difference with the reference distance difference and compares the actual angle difference with the reference angle difference respectively to obtain corresponding comparison results, and determines whether the installation of the 3D camera 2 satisfies the requirement according to the comparison results. In detail, the analysis module 105 determines the installation of the 3D camera 2 satisfies the requirement if the distance difference is less than the reference distance difference and the angle difference is less than the reference angle difference. The analysis module 105 determines the 3D camera 2 does not satisfy the requirement if the distance difference is greater than the reference distance difference or the angle difference is greater than the reference angle difference.

In step S406, the analysis module 105 controls the prompt module 106 to produce corresponding prompt signal according to the comparison results.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A camera testing device for testing whether a 3D camera is installed appropriately, the 3D camera comprises a first camera and a second camera, the camera testing device comprising:
a storing module storing a reference distance difference and a reference angle difference;
a image capturing module, configured to obtain images captured by the first camera and the second camera of the 3D camera, wherein, the 3D camera is aimed at a reference picture to capture images corresponding to the reference picture and the first camera is aligned with a first picture of the reference picture, the reference picture further comprises a second picture, the first picture and the second picture both are rectangles, and a central point of the first picture has a first label, a central point of the second picture has a second label;
a particular point determining module, configured to analyze the image captured by the second camera, and identify the first label, the second label, and the central point of the image captured by the second camera; and
a calculating module, configured to determine the coordinates of the first label, the second label, and the central point of the image captured by the second camera, and calculate an actual angle difference and an actual distance difference between an actual position of the second camera and a standard position;
an analysis module, configured to compare the actual distance difference with the reference distance difference and compares the actual angle difference with the reference angle difference respectively to obtain corresponding comparison results, and determine whether the 3D camera is installed appropriately according to the comparison results.

2. The camera testing device according to claim 1, wherein the calculating module calculates a coordinate distance according to the coordinates of the central point of the image captured by the second camera and the coordinates of the second label to obtain the actual distance difference, and calculates a slope of a connection line of the first label and the second label according to the coordinates of the first label and the coordinates of the second label to obtain the actual angle difference.

3. The camera testing device according to claim 1, wherein the analysis module determines the 3D camera is installed appropriately if the actual distance difference is less than the reference distance difference and the angle difference is less than the reference angle difference; the analysis module determines the 3D camera is not installed appropriately if the actual distance difference is greater than the reference distance difference or the angle difference is greater than the reference angle difference.

4. The camera testing device according to claim 1, further comprising a prompt module, wherein the analysis module is further configured to control the prompt module to produce corresponding prompt signal according to the comparison result.

5. The camera testing device according to claim 5, wherein the prompt module is an LED unit.

6. The camera testing device according to claim 5, wherein the prompt module is an audio output unit.

7. A method for testing a 3D camera, the 3D camera comprises a first camera and a second camera, wherein, the method is applied in a camera testing device of claim 1, the method comprising:
making the first camera of the 3D camera to be aligned with a first picture of a reference picture, wherein, the reference picture further comprises a second picture, the first picture and the second picture both are rectangles, and a central point of the first picture has a first label, a central point of the second picture has a second label;
obtaining an image captured by a second camera of the 3D camera;
analyzing the image captured by the second camera, and identifying the first label, the second label, and a central point of the image captured by the second camera;
determining the coordinates of the first label, the second label, and the central point of the image, and calculating an actual angle difference and an actual distance difference between the actual position of the second camera and a standard position according to the coordinates of the first label, the second label, and the central point; and
comparing the actual distance difference with the reference distance difference and compares the actual angle difference with the reference angle difference respectively to obtain corresponding comparison results, and determining whether the 3D camera is installed appropriately according to the comparison result.

8. The method according to claim 7, wherein the step “calculating an actual angle difference and an actual distance difference between the actual position of the second camera and a standard position according to the coordinates of the first label, the second label, and the central point” comprises:
calculating a coordinate distance according to the coordinates of the central point of the image captured by the second camera and the coordinates of the second label to obtain the actual distance difference; and
calculating a slope of a connection line of the first label and the second label according to the coordinates of the first label and the coordinates of the second label to obtain the actual angle difference.

9. The method according to claim 10, wherein the step “determining whether the 3D camera is installed appropriately according to the comparison result” comprises:
determining the installation of the 3D camera satisfies the requirement if the distance difference is less than the reference distance difference and the angle difference is less than the reference angle difference; and
determining the 3D camera does not satisfy the requirement if the distance difference is greater than the reference distance difference or the angle difference is greater than the reference angle difference.

10. The method according to claim 7, wherein the method further comprises:
controlling a prompt module to produce corresponding prompt signal according to the comparison results.
